(19) United States
(12) Patent Application Publication
(10) Pub. No.: US 2014/0178702 A1
(43) Pub. Date: Jun. 26, 2014

(54) SURFACE COATINGS

(71) Applicants: Anthony David Smith, Berkshire (GB); Kevin Richard West, Berkshire (GB)

(72) Inventors: Anthony David Smith, Berkshire (GB); Kevin Richard West, Berkshire (GB)

(73) Assignee: BP Exploration Operating Company Limited, Middlesex (GB)

(21) Appl. No.: 14/131,112

(22) PCT Filed: Jul. 6, 2012
(86) PCT No.: PCT/EP2012/063232

§ 371 Date: Feb. 5, 2014

Related U.S. Application Data
(60) Provisional application No. 61/505,235, filed on Jul. 7, 2011.

(51) Int. Cl. C09D 5/16

(52) U.S. Cl. CPC C09D 5/1625
USPC 428/457; 554/227; 428/411.1; 427/435; 427/428.01; 427/429; 427/421.1

(57) ABSTRACT

The invention relates to the use of a mono-, di- or tri-glyceride of citric acid, or a derivative thereof, as a clathrate hydrate adhesion reducer in a surface coating composition. The mono-, di- or tri glyceride of citric acid is preferably a mono-glyceride in which the fatty acid is a monocarboxylic acid having a branched or unbranched, saturated or unsaturated, aliphatic chain comprising between 12 and 20 carbon atoms, particularly oleic, linolenic, stearic or erucic acid. The surface coating composition can be used to coat at least part of a surface of an assembly for use in hydrocarbon production, transportation, storage or processing.

This invention relates to coatings for reducing clathrate hydrate adhesion to surfaces, particularly surfaces of assemblies used in hydrocarbon production, transportation, storage and processing. Such assemblies include, for example, pipelines, flowlines, connectors, valves, caps, tanks, separators, heat exchangers, remotely operated vehicles (ROVs) used in hydrocarbon operations and other assemblies which can come into contact with hydrocarbons where clathrate hydrates may form. Such assemblies may form part of a sub-sea assembly or a surface assembly.

The formation of clathrate hydrates in hydrocarbon production, transportation, storage and processing assemblies is a known problem for the oil and gas industry. Clathrate hydrates are ice-like compounds consisting of light hydrocarbon molecules encapsulated in an otherwise unstable water crystalline structure. These clathrate hydrates tend to form at high pressure and low temperature wherever a suitable gas and free water are present. Clathrate hydrate particles can adhere onto assembly surfaces and can agglomerate to form larger particles. Where hydrate particles adhere to a surface, they can build up undesirably. A build up of hydrate particles can partially or completely block a flow path, prevent an assembly from operating correctly, and/or affect an assembly's buoyancy.

Although clathrate hydrate formation is a major problem for gas production, the formation of clathrate hydrates is also a problem for gas condensate and crude oil production.

It is known to add chemical treatments to a hydrocarbon fluid to attempt to control the formation of clathrate hydrates in hydrocarbon-handling assemblies. For example, thermodynamic inhibitors such as methanol, monoethylene glycol (MEG) and triethylene glycol (TEG) interact with the water phase to shift the hydrate formation curve to higher pressures and lower temperatures, and so expand the boundary of the operating conditions in which clathrate hydrates will not form. It is necessary to add thermodynamic hydrate inhibitors to hydrocarbon flows at relatively high concentrations (tens of percent). Recovery of the thermodynamic hydrate inhibitor is often therefore desirable, but this adds to processing time and costs.

Low dosage hydrate inhibitors (LDHIs) are required in much lower concentrations (1 to 3vol %) and generally may be divided into two categories: kinetic hydrate inhibitors (KHIs) and anti-agglomerants (AAs). KHIs generally comprise polymers with suitably sized pendant groups which enable the polymer to adsorb to the face of a hydrate particle, impeding further growth. The effect of KHIs is to slow down the rate at which clathrate hydrate particles increase in size. However, KHIs can impair oil/water separation in downstream processing steps and can be chemically incompatible with other additives such as corrosion inhibitors. Further, the efficacy of KHIs can be reduced if they are exposed to high subcoolings for too long (e.g. more than 10° C. below the hydrate temperature).

Anti-agglomerants typically contain quaternary ammonium salts which keep hydrate particles dispersed within the liquid hydrocarbon phase rather than allowing them to agglomerate into larger particles and potentially hydrate plugs. The use of quaternary ammonium salts can be environmentally undesirable.

WO 2010/080946 describes a non-stick apparatus whereby an article is coated with a non-stick material. The document describes application in petroleum production systems, refineries and pipelines thereof as well as food preparation articles such as saucepans, frying pans and casseroles. It is stated that the coating can be monotungsten carbide, ditungsten carbide, other carbides such as titanium carbide, tantalum carbide and/or zirconium carbide, a mixture thereof, or a mixture of tungsten carbides with tungsten or free carbon. It is said that the coating prevents or reduces scratching of the surface as well as sticking to the surface of solid depositions. It is stated that such depositions can be asphaltenes, waxes and hydrates formed from small hydrocarbons. It is stated that the coating can be applied by means of physical vapour deposition, chemical vapour deposition, roller coating, electrodeposition, or thermal spray.

WO 2009/145627 relates to a method of reducing clathrate hydrate adhesion to the interior surface of a conduit and associated equipment transporting or processing a fluid stream in oil and gas exploration and production, petroleum refining and/or petrochemistry. The document describes providing the conduit interior surface with a coating layer exhibiting a static contact angle of the sessile water drop on the coating layer in air higher than 75° at ambient air conditions, as measured according to ASTM D7334-08. The coating layer is said to comprise diamond like carbon (DLC) comprising fractions of one or more components selected from the group consisting of silicon, oxygen and fluor. However, the document does not teach a method of application of the coating layer.

Typically, DLC is applied to a surface by chemical vapour deposition. This technique would be unsuitable for coating surfaces of most assemblies used in hydrocarbon production, transportation, storage and processing due to the size of the assembly.

There is still a need for an alternative approach to reducing hydrate adhesion to surfaces, particularly in assemblies for hydrocarbon production, transportation, storage or processing.

The present invention teaches the use of a mono- or di-glyceride of citric acid, or a derivative thereof, as a clathrate hydrate adhesion reducer in a surface coating composition. The surface coating composition can be used to coat at least part of a surface of an assembly for use in hydrocarbon production, transportation, storage or processing.

There is also provided a method of reducing clathrate hydrate adhesion to a surface of an assembly for use in hydrocarbon production, transportation, storage or processing, the method comprising coating at least part of the surface of the assembly with a surface coating composition comprising a mono- or di-glyceride of citric acid, or a derivative thereof.

In accordance with another aspect of the invention, an assembly for use in hydrocarbon production, transportation, storage or processing comprises a surface which is at least partially coated by a coating comprising a mono- or di-glyceride of citric acid, or a derivative thereof.

The invention also provides a method of deploying a sub-sea hydrocarbon production, transportation, storage or processing assembly comprising coating at least part of a surface of the assembly with a surface coating composition comprising a mono- or di-glyceride of citric acid, or a derivative thereof, and lowering the assembly to a sub-sea location.

By the use of a mono- or di-glyceride of citric acid, or a derivative thereof, as a surface coating, the invention advantageously enables the reduction of clathrate hydrate adhesion to the surface, and so the invention provides benefits for assemblies for use in hydrocarbon production, transportation, storage or processing.

By mono- or di-glycerides of citric acid, it is meant a glycerol moiety covalently bonded to one (mono-) or two (di-) fatty acid groups by an ester link and also to a citric acid group also by an ester link. Where the glyceride is a mono-glyceride, two citric acid groups may optionally be bonded to the glycerol moiety.

Citric acid can also be known as 3-carboxy-3-hydroxy pentanedioic acid; 2-hydroxypropane-1,2,3-tricarboxylic acid; or 3-hydroxypentanedioic acid-3-carboxylic acid.

In the aspects of the invention described above, namely the use of a mono- or di-glyceride of citric acid or a derivative thereof, the method of reducing clathrate hydrate adhesion to a surface of any assembly for use in hydrocarbon production, transportation, storage or processing, the assembly for use in hydrocarbon production, transportation, storage or processing or the method of deploying a sub-sea hydrocarbon production, transportation, storage or processing assembly, where the mono- or di-glyceride of citric acid is a di-glyceride of citric acid, the fatty acids may be the same or different. For both mono- or di-glycerides of citric acid, the fatty acid(s) can separately be monocarboxylic or polycarboxylic acids having a branched or unbranched, saturated or unsaturated, aliphatic chain. If the fatty acid is a polycarboxylic acid, the derivative of the glyceride may be an ester of the fatty acid.

Suitably, each fatty acid comprises between 4 and 22, preferably between 12 and 22, carbon atoms. For example, each fatty acid can be oleic, linoleic, stearic, palmitic or erucic acid. Each fatty acid is suitably one which comprises 18 carbon atoms.

The mono- or di-glyceride of citric acid is preferably a mono-glyceride.

Suitably, the mono- or di-glyceride of citric acid is a glyceride of citric acid and oleic acid, a glyceride of citric acid and linoleic acid or a mixture thereof.

The mono- or di-glyceride of citric acid or a derivative thereof may be represented by the general formula (I):

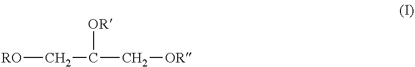

wherein RO, OR′ and OR″ independently represent:

—OH;

a saturated, mono-unsaturated or poly-unsaturated, branched or linear, monocarboxylic or polycarboxylic acid group having from 4 to 22 carbon atoms or an ester thereof;

a citric acid moiety or an ether and/or ester thereof;

provided that at least one of RO, OR′ and OR″ is a saturated, mono-unsaturated or poly-unsaturated, branched or linear, monocarboxylic acid group having from 4 to 22 carbon atoms or an ether or an ester thereof and at least one of RO, OR′ and OR″ is a citric acid moiety or an ether and/or ester thereof.

In formula (I), each saturated, branched or linear, monocarboxylic or polycarboxylic acid group having from 4 to 22 carbon atoms or an ester thereof may be derivable from saturated carboxylic acids or their halide equivalents. Suitable saturated carboxylic acids include for example, caproic acid, caprylic acid, capric acid, lauric acid, myristic acid, palmitic acid, stearic acid and arachidic acid.

In formula (I), each mono-unsaturated or poly-unsaturated, branched or linear, monocarboxylic or polycarboxylic group having from 4 to 22 carbon atoms or an ester thereof may be derivable from unsaturated carboxylic acids or their halide equivalents. Suitable mono-unsaturated and poly-unsaturated acids include for example, oleic acid, linoleic acid, linolenic acid, myristoleic acid, palmitoleic acid, sapienic acid, erucic acid and brassidic acid.

The glyceride may be a glyceride of citric acid and a saturated C₄ to C₂₂ polycarboxylic acid, or a derivative thereof. The polycarboxylic acid may be branched or linear. The glyceride may be a glyceride of citric acid and mono-unsaturated or polyunsaturated C₄ to C₂₂ polycarboxylic acid, or a derivative thereof. The polycarboxylic acid may be branched or linear.

The glyceride may be a glyceride of citric acid and a saturated C₄ to C₂₂ mono-carboxylic acid, or a derivative thereof. The mono-carboxylic acid may be branched or linear. The glyceride may be a glyceride of citric acid and a mono-unsaturated or poly-unsaturated C₄ to C₂₂ mono-carboxylic acid, or a derivative thereof. The unsaturated mono-carboxylic acid may be branched or linear.

The glyceride may be a glyceride of citric acid and an unsaturated C₁₈ mono-carboxylic acid, or a derivative thereof. The unsaturated monocarboxylic acid may be branched or linear.

The glyceride may be a citric acid ester of a mono-glyceride of a saturated, mono-unsaturated or poly-unsaturated, branched or linear, C₄ to C₂₂ monocarboxylic acid, suitably a C₁₆ or C₁₈ carboxylic acid for example oleic, linoleic, stearic, palmitic or erucic acid. The glyceride may be a citric acid ester of mono-glyceride made from vegetable oil, for example sunflower oil and/or palm oil. The glyceride may be a citric acid ester of mono-glyceride made from edible, refined sunflower and palm based oil. Preferably, the glyceride is a glyceride of citric acid and oleic acid, a glyceride of citric acid and linoleic acid or a mixture thereof. A suitable source of glycerides of citric acid with oleic acid and/or linoleic acid is Grinsted® Citrem SP70 (Trade Mark), available from Danisco. Grinsted SP70 is believed to be a citric acid ester of mono-glyceride made from edible, refined sunflower and palm based oil. Grinsted Citrem SP70 may be represented by the structural formula (II):

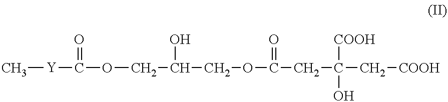

where —Y represents a C₁₆ hydrocarbyl moiety which is mono- or di-unsaturated.

Structural formula (II) thus includes a glyceride of citric acid and oleic acid and a glyceride of citric acid and linoleic acid. This corresponds to structural formula (I) in which (i) RO represents a carboxyl group having 18 carbon atoms, which may be derivable from oleic acid and/or linoleic acid, (ii) OR′ represents a hydroxyl moiety, and (iii) OR″ represents a citric acid moiety.

Citrem is known to be a hydrophilic emulsifier, for example from US 2009/0152502 (para 29), and is marketed by Danisco for use in food products. The use of Grinsted Citrem 2-in-1 from Danisco is described from paragraphs [0167] to [0171] of US patent application US 2008/0176778 as a carboxylic acid anionic surfactant.

In the present invention, Grinsted Citrem SP70 has the advantage over some of the known chemicals used in hydrate remediation treatments that it is not toxic.

In the embodiments of the present invention, the derivative of the mono- or di-glyceride of citric acid may be an ester of the citric acid moiety. The ester may be an ester of a carboxylic acid moiety of the citric acid. Each carboxylic acid moiety of the citric acid may be independently derivatisable as an ester. The ester derivative may be a hydrocarbyl ester, in which the hydrocarbyl moiety may have from 4 to 22 carbon atoms. The hydrocarbyl moiety may be an alkyl moiety which may have from 4 to 22 carbon atoms. The hydrocarbyl moiety may comprise one or more hetero atoms for example nitrogen and/or oxygen.

The derivative of the mono- or di-glyceride of citric acid may be an ether or an ester of the hydroxyl moiety of the citric acid moiety. If another hydroxy moiety is present in the mono- or di-glyceride of citric acid, each hydroxy moiety may independently be derivatisable as an ether or an ester. Each ether may be a hydrocarbyl ether. The hydrocarbyl moiety of each ether may independently have from 1 to 22 carbon atoms, more suitably from 1 to 18 carbon atoms. The hydrocarbyl moiety of each ether may independently be an alkyl moiety. The alkyl moiety of each ether may independently have from 1 to 22 carbon atoms, more suitably from 1 to 18 carbon atoms. The hydrocarbyl moiety of each ether may independently comprise one or more hetero atoms for example nitrogen and/or oxygen. Each ester may independently be a hydrocarbyl ester. The hydrocarbyl moiety of each ester may have from 4 to 22 carbon atoms. The hydrocarbyl moiety of each ester may independently be an alkyl moiety. The alkyl moiety of each ester may independently have from 4 to 22 carbon atoms. The hydrocarbyl moiety of each ester may independently comprise one or more hetero atoms for example nitrogen and/or oxygen.

The mono- or di-glyceride of citric acid and derivatives thereof can be made by methods known in the art. For example, partial hydrolysis of a fat may be used to produce a mono- or di-glyceride which may be esterified with citric acid. Hydrocarbyl derivatives may be made from corresponding hydrocarbyl halides.

In the aspects and embodiments of the present invention, the surface of the assembly for use in hydrocarbon production, transportation, storage or processing is preferably a metallic surface, typically a steel surface for example stainless steel or carbon steel.

The surface coating composition can be coated onto the surface by any technique known in the art, for example by painting e.g. brushing, smearing, dipping, spraying, rolling or rubbing. For example, where the surface is an internal surface of part of a pipeline section, the surface can be coated by moving a spray device through the pipeline section or by sending a ‘slug’ of the surface coating composition through the pipeline section. The latter can be achieved using two pigs (simple tools which can move along a pipeline, typically under hydraulic pressure) spatially separated from each other and moving through the pipeline section, wherein the surface coating composition fills the pipeline between the pigs. In this way, the internal surface of the pipeline section comes in contact with the surface coating composition and is thereby coated.

The method of coating may relate to the temperature of the surface coating composition. The surface coating composition can have a higher viscosity at lower temperatures, and may be solid, and so can suitably be smeared or rubbed onto a surface. At higher temperatures, the viscosity is typically reduced and may be liquid, and so the surface coating composition may be applied by brushing, spraying or dipping.

The use of a mono- or di-glyceride of citric acid, or a derivative thereof, as described in any of the embodiments herein, for a coating on a surface to reduce hydrate adhesion to that surface may be particularly advantageous where there is an absence of bulk water at the surface. By bulk water at the surface, it is meant water which has wetted the surface which is coated by the mono- or di-glyceride of citric acid, or a derivative thereof i.e. the water is contacting the coating.

For example, beneficially, the invention provides the use of a mono- or di-glyceride of citric acid, or a derivative thereof, as a clathrate hydrate adhesion reducer in a surface coating composition, where the surface coating composition can be used to coat at least part of a surface of an assembly for use in hydrocarbon production, transportation, storage or processing where there is an absence of bulk water at the surface.

In the second aspect of the invention identified herein, the invention preferably provides a method of reducing clathrate hydrate adhesion to a surface of an assembly for use in hydrocarbon production, transportation, storage or processing, wherein there is an absence of bulk water at the surface, the method comprising coating at least part of the surface of the assembly with a surface coating composition comprising a mono- or di-glyceride of citric acid, or a derivative thereof. The method may include positioning the assembly such that it is contacted by a hydrocarbon fluid wherein there is an absence of bulk water at the part of the surface of the assembly which is coated with the surface coating composition.

In accordance with the third aspect of the invention, the assembly is preferably for use in hydrocarbon production, transportation, storage or processing where there is an absence of bulk water at the surface.

In the fourth aspect of the invention, the method of deploying a sub-sea hydrocarbon production, transportation, storage or processing assembly preferably includes allowing that part of the surface of the assembly which is coated with the surface coating composition to be contacted by a hydrocarbon fluid in the absence of bulk water at that surface.

The invention will now be illustrated by way of example only with reference to the accompanying figures in which:

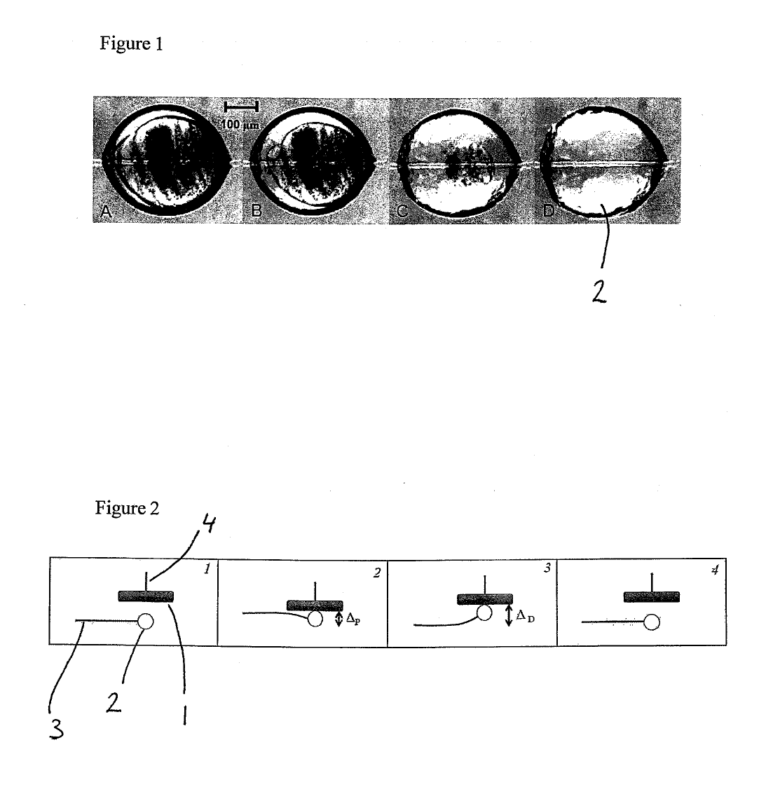

FIG. 1 shows a microscopic photograph of the conversion of an ice particle to a cyclopentane hydrate particle;

FIG. 2 depicts in schematic form the operation of a micromechanical force apparatus;

### EXAMPLE 1

The effect of a coating of Grinsted Citrem SP 70 on a stainless steel surface on adhesion of a cyclopentane hydrate particle (which is consistent with most hydrates encountered in hydrocarbon operations) to the stainless steel surface was tested. Stainless steel has a similar baseline surface free energy value to carbon steel.

A control test plus two tests using Grinsted Citrem SP70 were carried out. Each test was carried out immediately following the preceding test to minimise the effect of changes in operating conditions, such as humidity which can affect the micromechanical force apparatus (described below).

In the control test, a surface of Grade 309 stainless steel 1 was washed and lightly scrubbed in Sodosil® solution (approximately 10 wt %), an alkaline cleaner available from Sigma-Aldrich®, for five minutes. The surface was then submerged in ethanol for ten minutes and then in acetone for a further ten minutes. The surface was cured in cyclopentane liquid for at least 24 hours.

To prepare a clathrate hydrate particle 2, a sub-zero bath of cyclopentane located in an enclosure was brought to −5.0° C. Nitrogen gas was introduced into the enclosure so as to evacuate the enclosure of air. Using a dropper, a water droplet was placed on the end of a glass cantilever 3 which formed part of a micromechanical force (MMF) apparatus. The MMF apparatus was a Carl Zeiss Axiovert 5100 inverted microscope equipped with digital recording equipment.

The water droplet was quenched in liquid nitrogen for 20 seconds to convert it to ice. The ice particle was then placed in the sub-zero cyclopentane bath.

Cyclopentane liquid was placed in a beaker and nitrogen gas was bubbled there-through for the remainder of the experiment. The cyclopentane-saturated nitrogen gas was introduced into the enclosure to prevent cyclopentane liquid evaporating from the bath.

The temperature of the bath was raised to 2.7° C. (arbitrary, standard operating temperature at atmospheric pressure between the ice point and the hydrate dissociation point). The particle underwent an aging period of 50 minutes. The gradual conversion of the ice to hydrate can be seen in pictures A to D of FIG. 1.

After the aging period, the stainless steel surface 1 was inserted into the bath, coupled to a second glass cantilever 4 of the MMF apparatus, and a period of five minutes was allowed for temperature equilibration.

The adhesion between the stainless steel surface 1 and the hydrate particle 2 was measured 40 times (40 “pull offs”) as follows and using the apparatus shown schematically in FIG. 2. The stainless steel surface 1, attached to the second cantilever 4, was moved towards the hydrate particle 2 carried on the first glass cantilever 3 (picture 1, FIG. 2). The steel surface 1 was pushed against the hydrate particle 2 so that a force (p) was applied to the particle 2 (picture 2, FIG. 2). The second cantilever 4, carrying the steel surface 1, was then pulled away from the hydrate particle 2. The adhesion between the stainless steel surface 1 and the hydrate particle 2 caused the first cantilever 3, carrying the hydrate particle, to be pulled with the second cantilever 4 until the force applied to the second cantilever was greater than the adhesion force between the stainless steel surface and the hydrate particle. The hydrate particle 2 was therefore displaced a distance AD (picture 3, FIG. 2) before being released (picture 4, FIG. 2).

A waiting period of 10 seconds was allowed before repeating, to a total of 40 “pull offs”.

The maximum adhesion force, F, between the stainless steel surface and the hydrate particle was calculated using the equation:

F=k.D

where k is the spring constant of the first cantilever, carrying the hydrate particle.

The average of the 40 force measurements was calculated and is shown in column A of Table 1 (below).

To perform the first experimental test, Grinsted Citrem SP70, available from Danisco, was stored at 60° C. for two hours. The stainless steel surface 1 was removed from the bath after the control test, and dipped for five minutes in the Grinsted Citrem SP70 at 60° C. The stainless steel surface 1 was removed from the Grinsted Citrem SP70 and lightly wiped using a Kimwipe® from Kimberley Clark Corporation to remove excess liquid, and then dried for 60 minutes at room temperature.

A hydrate particle 2 was prepared as described above for the control, though the aging period in the cyclopentane bath was 60 minutes.

After the aging period, the stainless steel surface, now coated with Citrem SP 70, was placed in the cyclopentane bath and a period of five minutes was allowed for temperature equilibration.

The adhesion between the stainless steel surface coated in Grinsted Citrem SP70 and the hydrate particle was measured 40 times (40 “pull offs”) and the maximum adhesion force, F, between surface and the particle was calculated, as described above. The average of the 40 force measurements was calculated and is shown in column B of Table 1.

The stainless steel surface coated in Grinsted Citrem SP70 was removed from the cyclopentane bath and stored in a closed environment in the presence of vaporised cyclopentane at room temperature.

To perform the second experimental test, a hydrate particle was prepared as described above for the control, though the aging period in the cyclopentane bath was 72 minutes. After the aging period, the stainless steel surface coated in Grinsted Citrem SP70 was transferred from the closed environment to the cyclopentane bath and a period of five minutes was allowed for temperature equilibration.

The adhesion between the stainless steel surface coated in Grinsted Citrem SP70 and the hydrate particle was measured 40 times (40 “pull offs”) and the maximum adhesion force, F, between the surface and the particle was calculated, as described above. The average of the 40 force measurements was calculated and is shown in column C of Table 1.

TABLE 1

| Condition | A | B | C |
|---|---|---|---|
| Particle diameter | 903 | 1348 | 1607 |
| (microns) | | | |
| Particle ageing | 50 | 60 | 72 |
| time (minutes) | | | |
| Number of pull-offs | 40 | 40 | 40 |
| Average contact | 1.76 | 1.25 | 0.81 |
| force (mN/m) | | | |
| Average adhesion | 2.30 | 0.04 | 0.06 |
| force (mN/m) | | | |
| Minimum adhesion | 0.89 | 0.00 | 0.00 |
| force (mN/m) | | | |
| Maximum adhesion | 3.71 | 0.09 | 0.14 |
| force (mN/m) | | | |
| Improvement from | — | 98 | 97 |
| baseline (%) | | | |

It can be seen from Table 1 that there is a significant reduction in the adhesion force between a hydrate particle and a stainless steel surface coated in Grinsted Citrem SP70 compared with a hydrate particle and an uncoated stainless steel surface. In the first test, a 98% improvement was observed; in the second test, a 97% improvement was observed.

### EXAMPLE 2

The effect of a coating of Grinsted Citrem SP70 on a stainless steel surface on adhesion of a cyclopentane hydrate particle to the coated stainless steel surface was tested in the presence of saltwater.

A control test plus 5 tests using Grinsted Citrem SP70 were carried out. Each test was carried out immediately following the preceding test to minimise the effect of changes in operating conditions, such as humidity which can affect the micromechanical force apparatus (described below).

The control test was carried out in the same way as described above with respect to Example 1 except that the cyclopentane bath was modified as follows. In a separate bottle, equal amounts of cyclopentane and saltwater (3.5 wt % sodium chloride (NaCl) in deionised water) were shaken vigorously together for one minute. The top phase was drawn off using a syringe to obtain saltwater-saturated cyclopentane. The syringe was cooled. The uncoated stainless steel surface was then inserted into the cyclopentane bath and the cooled saltwater-saturated cyclopentane was injected into the bath to obtain a solution of saltwater dissolved in cyclopentane. The adhesion force measurements were taken as described above in Example 1, and the results for the control are shown in column A of Table 2 below.

Six experimental tests were carried out using the method described above with respect to Example 1 except that, in each test, the cyclopentane bath was modified as above so as to achieve different dissolved saltwater concentrations (see Table 2 below). Additionally, after dipping the uncoated stainless steel surface in Grinsted Citrem SP70, the surface was allowed to dry for 120 minutes at room temperature.

The average adhesion force measurements for the six experimental tests are shown in columns B to G respectively.

TABLE 2

| Condition | A | B | C | D | E | F | G |
|---|---|---|---|---|---|---|---|
| Particle diameter | 1037 | 1157 | 1243 | 1142 | 1034 | 1150 | 1213 |
| (microns) | | | | | | | |
| Particle ageing | 70 | 85 | 82 | 80 | 77 | 85 | 75 |
| time (minutes) | | | | | | | |
| Concentration of | 0 | 89 | 104 | 48 | 71 | 96 | 124 |
| saltwater in bath | | | | | | | |
| (ppm) | | | | | | | |
| Number of pull-offs | 40 | 40 | 40 | 40 | 40 | 40 | 40 |
| Average contact | 2.15 | 2.30 | 1.84 | 2.04 | 2.27 | 1.99 | 1.88 |
| force (mN/m) | | | | | | | |
| Average adhesion | 4.36 | 0.11 | 0.36 | 0.19 | 0.21 | 0.09 | 0.19 |
| force (mN/m) | | | | | | | |
| Minimum adhesion | 2.07 | 0.00 | 0.00 | 0.00 | 0.00 | 0.00 | 0.00 |
| force (mN/m) | | | | | | | |
| Maximum adhesion | 6.65 | 0.23 | 0.87 | 0.55 | 0.75 | 0.19 | 0.63 |
| force (mN/m) | | | | | | | |
| Improvement from | — | 98 | 92 | 96 | 95 | 98 | 96 |
| baseline (%) | | | | | | | |

It can be seen from Table 2 that there is a significant reduction in the adhesion force between a hydrate particle and a stainless steel surface coated in Grinsted Citrem SP70 compared with a hydrate particle and an uncoated stainless steel surface in the presence of a range of saltwater concentrations.

### EXAMPLE 3

The effect of a coating of Grinsted Citrem SP70 on a stainless steel surface on adhesion of a cyclopentane hydrate particle to the stainless steel surface was tested in the presence of bulk saltwater.

Two sets of experiments were carried out. In each set, the first experiment (experiments A and A′) measured the adhesion force between a hydrate particle, made as described above with respect to Example 1, and a stainless steel surface coated with Grinsted Citrem SP70 using the method described above with respect to Example 1, except that the surface was dried for a period of 9 days in an atmosphere saturated with cyclopentane vapour at room temperature. These experiments were therefore analogous to the first and second experiments in Example 1 above. The results of these experiments are shown in columns A and A′ of Table 3.

In the second experiment of each set (experiments B and B′), a saltwater droplet (3.5 wt % sodium chloride (NaCl) in deionised water) was deposited onto the coated stainless steel surface before the surface was inserted into the cyclopentane bath. After insertion into the cyclopentane bath, the hydrate particle was contacted with the saltwater droplet four times (i.e. four pull-offs). The adhesion force between the hydrate particle and the saltwater droplet was measured for each pull-off The results of these experiments are shown in columns B and B′ of Table 3.

After contacting the hydrate particle with the saltwater droplet, residual saltwater was observed on the surface of the hydrate particle.

The hydrate particles were then allowed to age for 5 minutes (experiment B) and 10 minutes (experiment B′), after which the particles were contacted for 40 pull-offs with a dry part of the coated steel surface (experiments C and C′). The results of these experiments are shown in columns C and C′ of Table 3.

The same hydrate particle was used in experiments A, B and C and the same hydrate particle was used in experiments A′, B′ and C′.

TABLE 3

| Condition | A | B | C | A′ | B′ | C′ |
|---|---|---|---|---|---|---|
| Particle diameter | 1015 | 1015 | 1015 | 993 | 993 | 993 |
| (microns) | | | | | | |
| Cumulative particle | 65 | 75 | 80 | 60 | 70 | 80 |
| ageing time (minutes) | | | | | | |
| Number of pull-offs | 40 | 4 | 40 | 40 | 4 | 40 |
| Average contact | 2.60 | 2.01 | 2.99 | 2.32 | 2.38 | 2.14 |
| force (mN/m) | | | | | | |
| Average adhesion | 0.08 | 24.22 | 1.24 | 0.10 | 70.81 | 1.12 |
| force (mN/m) | | | | | | |
| Minimum adhesion | 0.00 | 22.48 | 0.472 | 0.00 | 69.66 | 0.95 |
| force (mN/m) | | | | | | |
| Maximum adhesion | 0.24 | 25.96 | 2.00 | 0.27 | 71.95 | 1.29 |
| force (mN/m) | | | | | | |
| Improvement from | 97 | — | 46 | 96 | — | 51 |
| baseline (%) * | | | | | | |

* Baseline taken from calibration test of Example 1 (column A, Table 1)

It can be seen that there is a significant reduction in the adhesion force between a hydrate particle and a stainless steel surface coated in Grinsted Citrem SP70 in experiments A and A′ (consistent with Example 1). There is a reduction in the adhesion force between a saltwater-wetted hydrate particle and a saltwater-dry stainless steel surface which is coated in Grinsted Citrem SP70 (experiments C and C′). Experiments B and B′ showed an increase in adhesion force between a saltwater-wetted hydrate particle and a saltwater-wetted stainless steel surface which is coated in Grinsted Citrem SP70.

Visual inspection of the hydrate particles in experiments C and C′ suggest that the bulk water present on the hydrate particles after experiments B and B′ was converted to hydrate over a period of about 10 minutes. Thus most of the bulk water had converted to hydrate over the 10 minute aging period in experiment C′, whereas conversion of bulk water to hydrate was ongoing after the 5 minute aging period in experiment C. This is evidenced by a greater maximum adhesion force measured in experiment C than in experiment C′—these measurements correspond to the early measurements when there was still bulk water on the surface of the hydrate particle in experiment C. The minimum adhesion force measured in experiments C and C′ are similar, since these correspond to later measurements when all of the bulk water had been converted to hydrate. In experiments B and B′, it is believed that the water formed a capillary liquid bridge between the coated stainless steel surface and the hydrate particle.

1-13. (canceled)

14. A method of reducing clathrate hydrate adhesion to a surface of an assembly for use in hydrocarbon production, transportation, storage or processing, comprising coating at least part of the surface of the assembly with a surface coating composition comprising a mono- or di-glyceride of citric acid, or a derivative thereof.

15. The method according to claim 14 in which the surface coating composition is coated onto the surface by painting, dipping, smearing, spraying, rolling or rubbing.

16. The method according to claim 14 in which the fatty acid(s) of the mono or di-glycerides of citric acid are separately monocarboxylic or polycarboxylic acids having a branched or unbranched, saturated or unsaturated aliphatic chain.

17. The method according to claim 16 in which each fatty acid of the mono or di-glyceride of citric acid comprises between 4 and 22 carbon atoms.

18. The method according to claim 17 in which each fatty acid comprises between 12 and 22 carbon atoms.

19. The method according to claim 18 in which each fatty acid is oleic, linoleic, stearic, palmitic or erucic acid.

20. The method according to claim 19 in which each fatty acid comprises 18 carbon atoms.

21. The method according to claim 14 in which the mono- or di-glyceride of citric acid is a mono-glyceride.

22. The method according to claim 21 in which the mono-glyceride is a mono-glyceride of citric acid with oleic acid, a mono-glyceride of citric acid and linoleic acid or a mixture thereof.

23. The method according to claim 14 in which the mono- or di-glyceride of citric acid or a derivative thereof is represented by the general formula (I): 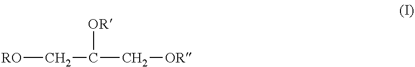
wherein RO, OR′ and OR″ independently represent:
—OH;
a saturated, mono-unsaturated or poly-unsaturated, branched or linear, monocarboxylic or polycarboxylic acid group having from 4 to 22 carbon atoms or an ester thereof;
a citric acid moiety or an ether and/or ester thereof;
provided that at least one of RO, OR′ and OR″ is a saturated, mono-unsaturated or poly-unsaturated, branched or linear, monocarboxylic acid group having from 4 to 22 carbon atoms or an ether or an ester thereof and at least one of RO, OR′ and OR″ is a citric acid moiety or an ether and/or ester thereof.

24. The method according to claim 14 in which the surface is a steel surface.

25. A method of deploying a sub-sea hydrocarbon production, transportation, storage or processing assembly comprising coating at least part of a surface of the assembly with a surface coating composition comprising a mono- or di-glyceride of citric acid, or a derivative thereof, and lowering the assembly to a sub-sea location.

26. The method according to claim 25 in which the surface coating composition is coated onto the surface by painting, dipping, smearing, spraying, rolling or rubbing.

27. The method according to claim 25 in which the fatty acid(s) of the mono or di-glycerides of citric acid are separately monocarboxylic or polycarboxylic acids having a branched or unbranched, saturated or unsaturated aliphatic chain.

28. The method according to claim 27 in which each fatty acid of the mono or di-glyceride of citric acid comprises between 4 and 22 carbon atoms.

29. The method according to claim 28 in which each fatty acid comprises between 12 and 22 carbon atoms.

30. The method according to claim 29 in which each fatty acid is oleic, linoleic, stearic, palmitic or erucic acid.

31. The method according to claim 30 in which each fatty acid comprises 18 carbon atoms.

32. The method according to claim 25 in which the mono- or di-glyceride of citric acid is a mono-glyceride.

33. The method according to claim 32 in which the mono-glyceride is a mono-glyceride of citric acid with oleic acid, a mono-glyceride of citric acid and linoleic acid or a mixture thereof.

34. The method according to claim 25 in which the mono- or di-glyceride of citric acid or a derivative thereof is represented by the general formula (I): 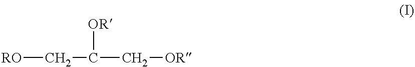
wherein RO, OR′ and OR″ independently represent:
—OH;
a saturated, mono-unsaturated or poly-unsaturated, branched or linear, monocarboxylic or polycarboxylic acid group having from 4 to 22 carbon atoms or an ester thereof;
a citric acid moiety or an ether and/or ester thereof;
provided that at least one of RO, OR′ and OR″ is a saturated, mono-unsaturated or poly-unsaturated, branched or linear, monocarboxylic acid group having from 4 to 22 carbon atoms or an ether or an ester thereof and at least one of RO, OR′ and OR″ is a citric acid moiety or an ether and/or ester thereof.

35. The method according to claim 25 in which the surface is a steel surface.

36. Use of a mono- or di-glyceride of citric acid, or a derivative thereof, as a clathrate hydrate adhesion reducer in a surface coating composition.

37. The use according to claim 36 in which the surface coating composition is used to coat at least part of a surface of an assembly for use in hydrocarbon production, transportation, storage or processing.

38. The use according to any one of claims 36 in which the surface coating composition is coated onto the surface by painting, dipping, smearing, spraying, rolling or rubbing.

39. An assembly for use in hydrocarbon production, transportation, storage or processing comprising a surface which is at least partially coated by a coating comprising a mono- or di-glyceride of citric acid, or a derivative thereof.

40. The assembly according to claim 39 in which the surface coating composition is coated onto the surface by painting, dipping, smearing, spraying, rolling or rubbing.

41. The assembly according claim 39 in which the fatty acid(s) of the mono or di-glycerides of citric acid are separately monocarboxylic or polycarboxylic acids having a branched or unbranched, saturated or unsaturated aliphatic chain.

42. The assembly according to claim 41 in which each fatty acid of the mono or di-glyceride of citric acid comprises between 4 and 22 carbon atoms.

43. The assembly according to claim 42 in which each fatty acid comprises between 12 and 22 carbon atoms.

44. The assembly according to claim 43 in which each fatty acid is oleic, linoleic, stearic, palmitic or erucic acid.

45. The assembly according to claim 44 in which each fatty acid comprises 18 carbon atoms.

46. The assembly according to claim 39 in which the mono- or di-glyceride of citric acid is a mono-glyceride.

47. The assembly according to claim 46 in which the mono-glyceride is a mono-glyceride of citric acid with oleic acid, a mono-glyceride of citric acid and linoleic acid or a mixture thereof.

48. The assembly according to claim 39 in which the mono- or di-glyceride of citric acid or a derivative thereof is represented by the general formula (I): 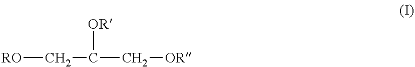
wherein RO, OR′ and OR″ independently represent:
—OH;
a saturated, mono-unsaturated or poly-unsaturated, branched or linear, monocarboxylic or polycarboxylic acid group having from 4 to 22 carbon atoms or an ester thereof;
a citric acid moiety or an ether and/or ester thereof;
provided that at least one of RO, OR′ and OR″ is a saturated, mono-unsaturated or poly-unsaturated, branched or linear, monocarboxylic acid group having from 4 to 22 carbon atoms or an ether or an ester thereof and at least one of RO, OR′ and OR″ is a citric acid moiety or an ether and/or ester thereof.

49. The assembly according to claim 39 in which the surface is a steel surface.
